(19) United States
(12) Patent Application Publication
(10) Pub. No.: US 2011/0192786 A1
(43) Pub. Date: Aug. 11, 2011

(54) FUEL FILTER

(75) Inventors: Takashi NAGAI, Handa-shi (JP); Koji YOSHIDA, Kasugai-shi (JP)

(73) Assignee: AISAN KOGYO KABUSHIKI KAISHA, Obu-shi (JP)

(21) Appl. No.: 13/020,863

(22) Filed: Feb. 4, 2011

(30) Foreign Application Priority Data
Feb. 9, 2010 (JP) 2010-0026395

(51) Int. Cl. B01D 35/027

(52) U.S. Cl. 210/443

(57) ABSTRACT

A fuel filter for filtering engine fuel received in a fuel tank when the engine fuel is fed to an engine may include a filter member that is received in the fuel tank and is capable of being connected to a fuel inlet port through which the engine fuel is drawn, and a wall member that is connected to a circumferential periphery of the filter member to form a container member. The wall member and the filter member are respectively arranged and constructed to function as a side portion and a bottom portion of the container member. The filter member is capable of being disposed in the fuel tank so as to draw the engine fuel received in the fuel tank through a side thereof that faces the bottom wall of the fuel tank.

### BACKGROUND OF THE INVENTION

The present invention relates to a fuel filter for filtering engine fuel received in a fuel tank. More particularly, the present invention relates to a fuel filter that is used in a fuel-feeding device of an engine (an internal combustion engine) of an automobile or a motorcycle.

In an automobile or a motorcycle, a fuel filter is disposed in a fuel tank in order to filtrate engine fuel received in the fuel tank and to remove contaminants (foreign substances) contained therein. Generally speaking, the fuel filter is attached to a fuel inlet port of a fuel pump that is disposed in the fuel tank.

A fuel filter is taught by, for example, Japanese Laid-Open Patent Publication No. 2004-245214. The fuel filter is attached to a fuel inlet port of a fuel pump that is disposed in the fuel tank. Further, the fuel inlet port of the fuel pump is positioned in a sub-tank (a reservoir cup) that is disposed in a fuel tank, so that the fuel pump can draw engine fuel received in the fuel tank even when an amount of the engine fuel in the fuel tank is reduced.

However, because the known fuel filter can be positioned in the sub-tank, the fuel filter must be arranged in and secured to the sub-tank using fixture members. As a result, the number of parts of a fuel-feeding device can be increased. This may lead to an increased cost of the fuel-feeding device and a larger and complicated structure of the fuel tank. Also, a work for securing the fuel filter to the sub-tank by the fixture members is complicated and time consuming.

Thus, there is a need in the art for an improved fuel filter.

### BRIEF SUMMARY OF THE INVENTION

For example, in one embodiment of the present invention, a fuel filter for filtering engine fuel received in a fuel tank when the engine fuel is fed to an engine may include a filter member that is received in the fuel tank and is capable of being connected to a fuel inlet port through which the engine fuel is drawn, and a wall member that is connected to a circumferential periphery of the filter member to form a container member. The wall member and the filter member are respectively arranged and constructed to function as a side portion and a bottom portion of the container member. The filter member is capable of being disposed in the fuel tank so as to draw the engine fuel received in the fuel tank through a side thereof that faces the bottom wall of the fuel tank.

According to the fuel filter thus constructed, the fuel filter (the container member) can function as a sub-tank. Therefore, it is not necessary to additionally provide a sub-tank to the fuel tank. This means that the number of parts of a fuel-feeding device having the fuel filter can be reduced. As a result, the fuel-feeding device can be easily and inexpensively manufactured. Further, the fuel-feeding device can be structurally simplified. In addition, the fuel tank can be reduced in size.

Further, the filter member can be positioned along the bottom wall of the fuel tank in contact therewith. Therefore, when the engine fuel received in the fuel tank is drawn into the fuel inlet port, the engine fuel can be effectively filtered by the filter member.

Optionally, the wall member can be connected to the circumferential periphery of the filter member by fusion bonding, so as to be integrated with the filter member.

Further, the wall member can be connected to the circumferential periphery of the filter member by fitting, so as to be integrated with the filter member.

Other objects, features, and advantages, of the present invention will be readily understood after reading the following detailed description together with the accompanying drawings and the claims.

### BRIEF DESCRIPTION OF THE DRAWINGS

FIG. 1 is a schematic cross-sectional view of a fuel-feeding device that has a fuel filter according to a first embodiment of the present invention;

FIG. 2 is a schematic cross-sectional view of a modified fuel-feeding device that has a modified fuel filter;

FIG. 3 is a schematic cross-sectional view of the fuel-feeding device, which view illustrates that the fuel filter can have a function as a sub-tank;

FIG. 4 is a schematic cross-sectional view of the modified fuel-feeding device, which view illustrates that the modified fuel filter can have the function as the sub-tank;

FIG. 5 is an enlarged partially schematic cross-sectional view of a fuel filter according to a second embodiment of the present invention, which illustrates a connecting method of a filter member and a wall member;

FIG. 6(A) is an enlarged partially schematic cross-sectional view of a fuel filter according to a third embodiment of the present invention;

FIG. 6(B) is an enlarged partially schematic cross-sectional view of a first modified form of the fuel filter;

FIG. 6(C) is an enlarged partially schematic cross-sectional view of a second modified form of the fuel filter;

FIG. 7(A) is an enlarged partially schematic cross-sectional view of a fuel filter according to a fourth embodiment of the present invention;

FIG. 7(B) is an enlarged partially schematic cross-sectional view of a fuel filter according to a fifth embodiment of the present invention

FIG. 7(C) is an enlarged partially schematic cross-sectional view of a first modified form of the fuel filter;

FIG. 7(D) is an enlarged partially schematic cross-sectional view of a second modified form of the fuel filter;

FIG. 8(A) is an enlarged partially schematic cross-sectional view of a fuel filter according to a sixth embodiment of the present invention;

FIG. 8(B) is an enlarged partially schematic cross-sectional view of a fuel filter according to a seventh embodiment of the present invention;

FIG. 8(C) is an enlarged partially schematic cross-sectional view of a first modified form of the fuel filter;

FIG. 8(D) is an enlarged partially schematic cross-sectional view of a second modified form of the fuel filter;

FIG. 9(A) is an enlarged partially schematic cross-sectional view of a fuel filter according to a eighth embodiment of the present invention;

FIG. 9(B) is an enlarged partially schematic cross-sectional view of a first modified form of the fuel filter; and

FIG. 9(C) is an enlarged partially schematic cross-sectional view of a second modified form of the fuel filter.

### DETAILED DESCRIPTION OF THE INVENTION

Next, the representative embodiments of the present invention will be described with reference to the drawings.

### First Embodiment

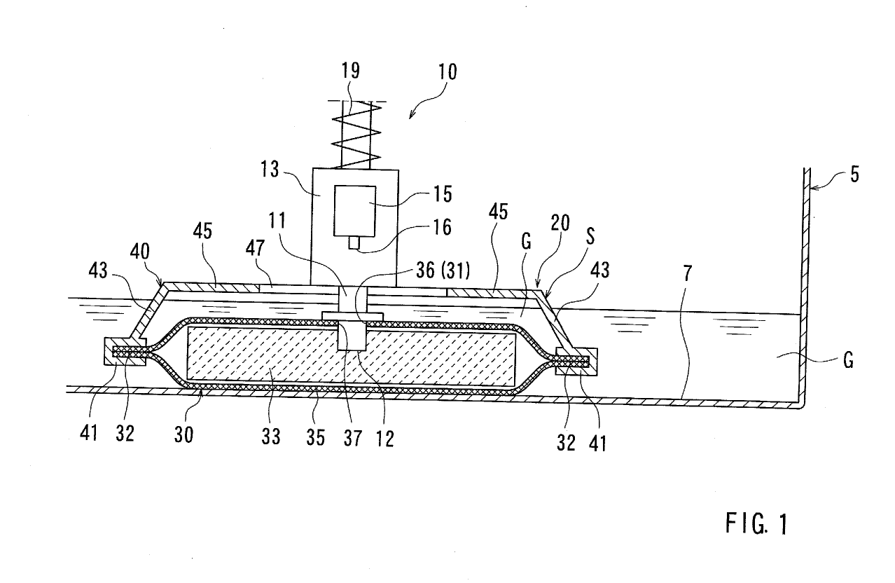

A first embodiment of the present invention will be described with reference to FIGS. 1 to 4. This embodiment of the present invention is directed to a fuel filter that is used in a fuel-feeding device of an engine (an internal combustion engine) of a vehicle such as a four-wheeled vehicle.

First, a fuel-feeding device 10 is described. As shown in FIG. 1, the fuel-feeding device 10 may preferably be disposed in a hollow fuel tank 5 of a vehicle (not shown) in which liquid fuel or gasoline G is received. The fuel-feeding device 10 may preferably include a suction pipe 11 (a gasoline flow conduit), a fuel filter 20, an immersion type fuel pump 13 that is capable of feeding (pumping) the gasoline G received in the fuel tank 5 to an engine (not shown), and a pressure regulator 15 that is connected to the fuel pump 13. The suction pipe 11, the fuel filter 20, the fuel pump 13, and the pressure regulator 15 are integrated with each other. Further, the fuel filter 20 is constructed of a filter member 30 and a (dish-shaped) wall member 40. The wall member 40 is circumferentially connected to the filter member 30, so as to be integrated therewith. The wall member 40 and the filter member 30 thus connected may form a container member S that is capable of functioning as a sub-tank. Further, the wall member 40 and the filter member 30 may respectively be referred to as a side portion and a bottom portion of the container member S.

The suction pipe 11 is connected to a fuel inlet port (not shown) of the fuel pump 13, so that the gasoline G can be introduced into the fuel pump 13 therethrough. The suction pipe 11 has a fuel inlet port 12. As shown in FIG. 1, the suction pipe 11 is connected to the filter member 30 that is positioned along a bottom wall 7 of the fuel tank 5 in contact therewith. In particular, the suction pipe 11 is connected to the filter member 30 while the fuel inlet port 12 is opened into the filter member 30. As a result, the fuel inlet port 12 of the suction pipe 11 can be positioned adjacent to the bottom wall 7 of the fuel tank 5.

As shown in FIG. 1, the fuel pump 13 is capable of pressurizing the gasoline G present in the suction pipe 11 and feeding the same to the engine. The pressure regulator 15 is capable of controlling a pressure (i.e., a gasoline pressure) of the gasoline pumped from the fuel pump 13 in order to suitably feed the same to the engine. Further, the pressure regulator 15 is capable of discharging the excess portion of the gasoline pumped from the fuel pump 13 into the fuel tank 5 as return gasoline. The return gasoline can be returned to the fuel tank 5 via a gasoline discharging port 16 formed in the pressure regulator 15. The gasoline discharging port 16 may preferably be positioned above an inflow opening 47 formed in an upper wall portion 45 of the wall member 40. Thus, the return gasoline discharged from the gasoline discharging port 16 can be introduced into the container member S (the sub-tank) via the inflow opening 47.

The fuel-feeding device 10 thus constructed may preferably be positioned adjacent to the bottom wall 7 of the fuel tank 5, so as to feed the gasoline G to the engine even when the gasoline received in the fuel tank 5 is reduced. Further, the fuel-feeding device 10 may preferably be biased toward the bottom wall 7 of the fuel tank 5 via a spring 19. One end of the spring 19 is connected to an upper wall (not shown) of the fuel tank 5 that is positioned opposite to the bottom wall 7 of the fuel tank 5. The other end of the spring 19 is connected to the fuel pump 13. Thus, the filter member 30 can be pressed against the bottom wall 7 of the fuel tank 5, so as to closely contact the same.

As previously described, the fuel filter 20 is constructed of the filter member 30 and the wall member 40 that are circumferentially connected to each other. Further, the fuel filter 20 is attached to the suction pipe 11 of the fuel-feeding device 10. In particular, the filter member 30 of the fuel filter 20 is connected to the suction pipe 11 that is introduced into the wall member 40 via the inflow opening 47 formed in the upper wall portion 45 of the wall member 40.

As described above, the filter member 30 may function as the bottom portion of the container S (the sub-tank). The filter member 30 is composed of a non-woven fabric filter element 33 and a bag-shaped mesh filter element 35. The non-woven fabric filter element 33 may preferably be formed of widely used non-woven fabric so as to filtrate fine contaminants contained in the gasoline G. The non-woven fabric filter element 33 has an area that permit the non-woven fabric filter element 33 to reliably function as the bottom portion of the sub-tank. In addition, the non-woven fabric filter element 33 has a thickness that permit the non-woven fabric filter element 33 to reliably filtrate the fine contaminants contained in the gasoline G when the gasoline G is drawn into the fuel pump 13 via the fuel inlet port 12. Further, as previously described, the filter member 30 and the suction pipe 11 are connected to each other while the fuel inlet port 12 is opened into the filter member 30. In particular, the filter member 30 and the suction pipe 11 are connected to each other while the fuel inlet port 12 is opened into the non-woven fabric filter element 33.

The mesh filter element 35 may preferably be formed of a material that is capable of absorbing and holding (trapping) the gasoline G thereon. Preferably, the mesh filter element 35 is formed of a fine mesh material that is made of nylon resin. Further, the mesh filter element 35 is positioned to encapsulate the non-woven fabric filter element 33. In particular, the mesh filter element 35 is composed of two mesh sheets slightly greater than the non-woven fabric filter element 33. The mesh sheets are fusion bonded to each other along circumferential peripheries thereof while the non-woven fabric filter element 33 is sandwiched therebetween. Thus, the mesh filter element 35 is integrated with the non-woven fabric filter element 33 while covering an outer surface of the non-woven fabric filter element 33, so that the filter member 30 can be formed. Further, as shown in FIG. 1, when the mesh sheets are bonded along the circumferential peripheries thereof, a bonded portion can be formed therealong. The bonded portion thus formed may define a circumferential periphery 32 of the filter member 30.

As described above, because the mesh filter element 35 is formed of the fine mesh material having fine meshed portions, the mesh filter element 35 is capable of holding the gasoline G in the fine meshed portions thereof. Therefore, the gasoline G held in the fine meshed portions of the mesh filter element 35 can function to further absorb the other gasoline G Thus, the mesh filter element 35 can effectively function to absorb the gasoline G.

As described above, the filter member 30 and the suction pipe 11 are connected to each other while the fuel inlet port 12 is introduced into the non-woven fabric filter element 33 of the filter member 30. To this end, as shown in FIG. 1, the mesh filter element 35 has a through hole 37 through which the suction pipe 11 can be inserted, so that the fuel inlet port 12 can be introduced into the non-woven fabric filter element 33. The through hole 37 may preferably be formed in a central portion 36 of the mesh filter element 35. Further, the central portion 36 of the mesh filter element 35 corresponds to a central portion 31 of the filter member 30.

Further, the filter member 30 is disposed in the fuel tank 5 while contacting the bottom wall 7 of the fuel tank 5, so that the gasoline G received in the fuel tank 5 can be drawn into the fuel inlet port 12 of the suction pipe 11 through a side of the filter member 30 that faces the bottom wall 7. Further, the filter member 30 is positioned such that the gasoline G received in the container member S (the sub-tank) can be drawn into the fuel inlet port 12 therethrough.

The wall member 40 is integrally connected to the circumferential periphery 32 of the filter member 30. In particular, the wall member 40 has a connecting portion 41 formed in a side wall portion 43 thereof, which connecting portion is connected to the circumferential periphery 32 of the filter member 30, so that the container member S (the sub-tank) having a cavity therein can be defined by the wall member 40 and the filter member 30. The wall member 40 may preferably be integrally formed of polyacetal resin. Further, the polyaceal resin has a melting point that is lower than the nylon resin for the mesh filter element 35.

As shown in FIG. 1, the connecting portion 41 of the wall member 40 has a U-shape in cross section, so as to engage the circumferential periphery 32 of the filter member 30. As described above, because the connecting portion 41 is formed of the polyaceal resin, the connecting portion 41 has a melting point that is lower than the circumferential periphery 32 of the filter member 30. Therefore, when the connecting portion 41 is heated, the connecting portion 41 can be melted whereas the circumferential periphery 32 of the filter member 30 is not melted. As a result, the connecting portion 41 is fusion bonded to the circumferential periphery 32 of the filter member 30, so that the wall member 40 can be integrated with the filter member 30. Thus, the container member S (the sub-tank) can be defined by the wall member 40 and the filter member 30.

The side wall portion 43 of the wall member 40 can function as a container side wall portion of the container member S. The side wall portion 43 of the wall member 40 extends upwardly relative to the circumferential periphery 32 of the filter member 30. More particularly, the side wall portion 43 of the wall member 40 extends obliquely upwardly relative to the circumferential periphery 32 of the filter member 30 while being inclined toward the central portion 31 of the filter member 30.

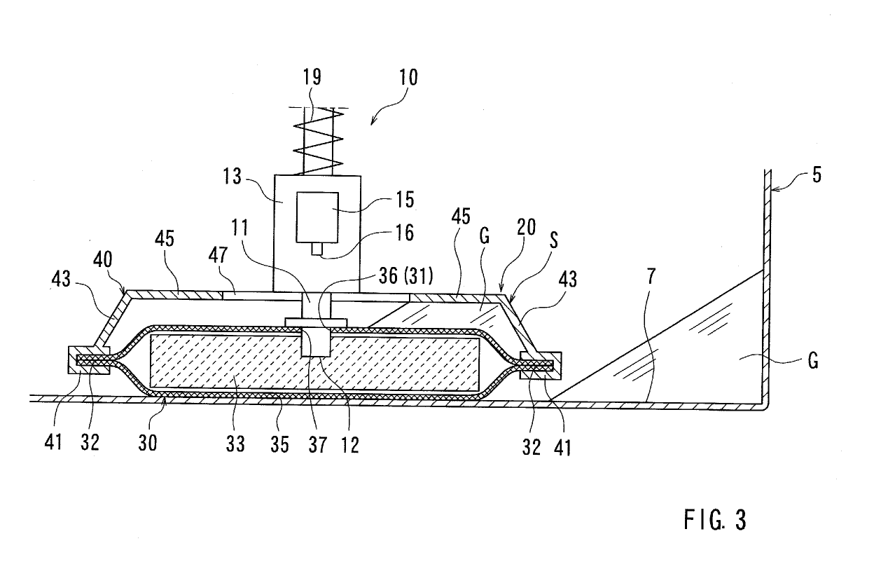

Further, the upper wall portion 45 of the wall member 40 can function as a container upper wall portion of the container member S. The upper wall portion 45 of the wall member 40 extends laterally inwardly from an upper circumferential periphery of the side wall portion 43. As previously described, the upper wall portion 45 has the inflow opening 47 formed therein. Therefore, the upper wall portion 45 substantially has an annular shape. That is, the upper wall portion 45 is formed as a flange that extends along the upper circumferential periphery of the side wall portion 43. The upper wall portion 45 thus constructed can effectively prevent the gasoline G present in the container member S from easily flowing out of the container member S when the fuel tank 5 is inclined or vibrated while the vehicle is moving (FIG. 3). Therefore, it is not necessary to increase a height of the side wall member 43 in order to prevent the gasoline G present in the container member S from easily flowing out of the container member S. As a result, the fuel tank 5 can be reduced in height.

Thus, the wall member 40 is integrated with the filter member 30, so as to form the container member S that is capable of functioning as the sub-tank. Further, the wall member 40 and the filter member 30 can respectively function as the side portion and the bottom portion of the container member S (the sub-tank) that is disposed on the bottom wall 7 of the fuel tank 5 while the filter member 30 contacts the bottom wall 7. When the gasoline G received in the fuel tank 5 is drawn into the fuel inlet port 12 of the suction pipe 11 through the side of the filter member 30 that faces the bottom wall 7, the fine contaminants contained in the gasoline G can be filtered by the filter member 30.

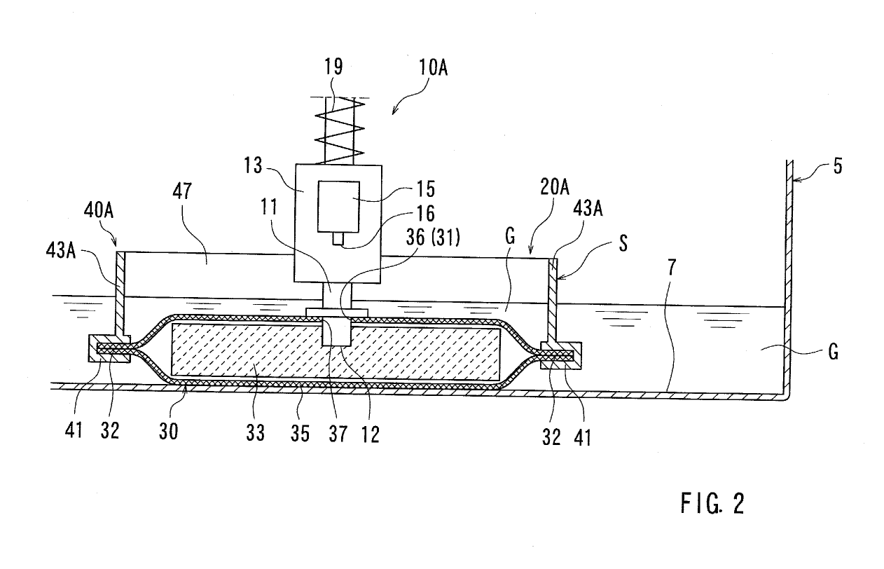

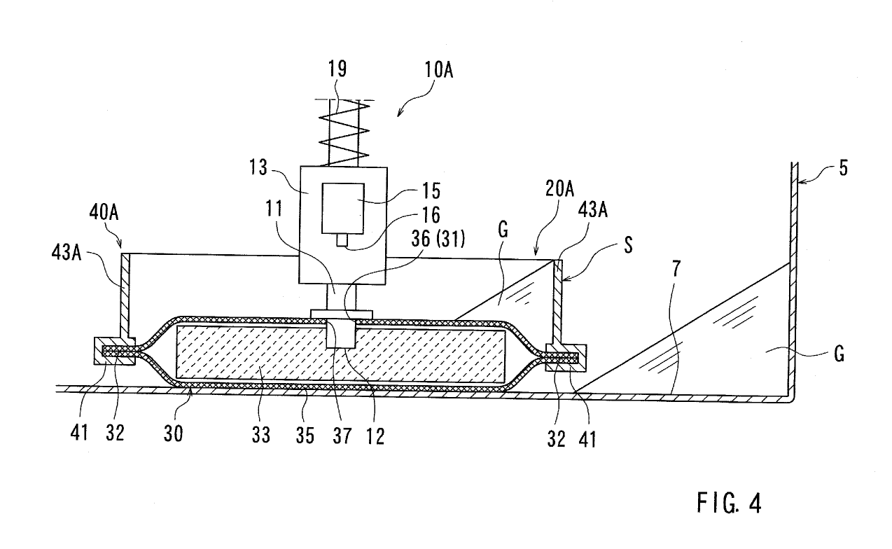

The fuel-feeding device 10 can be modified. A modified fuel-feeding device 10A will be described with reference to FIGS. 2 and 4.

Because the fuel-feeding device 10A is similar to the fuel-feeding device 10, only the constructions and elements that are different from the first embodiment will be explained in detail. Elements that are the same in the first embodiment and the modified form will be identified by the same reference numerals and a detailed description of such elements may be omitted.

As shown in FIG. 2, the fuel-feeding device 10A includes a fuel filter 20A having a wall member 40A. Similar to the wall member 40, the wall member 40A includes a side wall portion 43A. However, unlike the side wall portion 43 of the wall member 40, the side wall portion 43A of the wall member 40A extends vertically upwardly relative to the circumferential periphery 32 of the filter member 30. That is, the side wall portion 43A of the wall member 40a is not inclined relative to the circumferential periphery 32 of the filter member 30. In addition, unlike the wall member 40, the wall member 40A does not have an upper wall portion corresponding to the upper wall portion 45 of the wall member 40. That is, an upper circumferential periphery of the side wall portion 43A is fully opened.

According to the fuel-feeding device 10A thus constructed, the wall member 40A can be simplified. As a result, the wall member 40A can be easily and inexpensively manufactured. Further, similar to the fuel-feeding device 10, the gasoline G present in the container member S can be prevented from easily flowing out of the container member S when the fuel tank 5 is inclined or vibrated while the vehicle is moving (FIG. 4).

The fuel filter 20 (20A) of the fuel-feeding device 10 (10A) may have various effects. For example, the wall member 40 (40A) and the filter member 30 of the fuel filter 20 (20A) can form the container member S. Further, the wall member 40 (40A) and the filter member 30 can function as the side portion and the bottom portion of the container member S. Thus, as shown in FIGS. 3 and 4, the fuel filter 20 (20A) is capable of functioning as the sub-tank. Therefore, it is not necessary to additionally provide a sub-tank to the fuel tank 5. This means that the number of parts of the fuel-feeding device 10 (10A) can be reduced. As a result, the fuel-feeding device 10 (10A) can be easily and inexpensively manufactured. Further, the fuel tank 5 can be structurally simplified. In addition, the fuel tank 5 can be reduced in size.

Further, the filter member 30 is disposed in the fuel tank 5 while contacting the bottom wall 7 of the fuel tank 5, so that the gasoline G received in the fuel tank 5 can be drawn into the fuel inlet port 12 of the suction pipe 11 through the side of the filter member 30 that faces the bottom wall 7. Therefore, when the gasoline G received in the fuel tank 5 is drawn into the fuel inlet port 12 of the suction pipe 11, the contaminants contained in the gasoline G can be filtered by the filter member 30.

The filter member 30 has the non-woven fabric filter element 33. Therefore, the fuel filter 20 (20A) is capable of filtering the fine contaminants contained in the gasoline G when the gasoline G received in the fuel tank 5 is drawn by the fuel pump 13. Further, the filter member 30 has the mesh filter element 35. The mesh filter element 35 is formed of the material that is capable of absorbing and holding the gasoline G thereon and is positioned to encapsulate the non-woven fabric filter element 33. Therefore, even when the gasoline received in the fuel tank 5 is reduced, the gasoline G can be absorbed and collected by the fuel filter 20 (20A). As a result, the gasoline G can be effectively and continuously drawn by the fuel pump 13, so as to be fed to the engine. Thus, discontinuous combustion of the engine can be effectively avoided.

Further, the connecting portion 41 of the wall member 40 (40A) is fusion bonded to the circumferential periphery 32 of the filter member 30 by heating, so that the wall member 40 (40A) can be integrated with the filter member 30. Therefore, it is not necessary to use any connecting members in order to integrate the wall member 40 (40A) with the filter member 30. This means that the number of parts of the fuel filter 20 (20A) can be reduced. As a result, the fuel-feeding device 10 (10A) can be easily and inexpensively manufactured. Further, the fuel-feeding device 10 (10A) can be structurally simplified. In addition, the fuel tank 5 can be reduced in size.

Further, in order to integrate the wall member 40 (40A) with the filter member 30, the connecting portion 41 of the wall member 40 (40A) can be bonded to the circumferential periphery 32 of the filter member 30 while the wall member 40 (40A) is molded. That is, the wall member 40 (40A) can be integrated with the filter member 30 by insert molding. According to this method, the fuel filter 20 (20A) can be easily and quickly assembled. As a result, the fuel-feeding device 10 (10A) can be easily and inexpensively manufactured.

### Second Embodiment

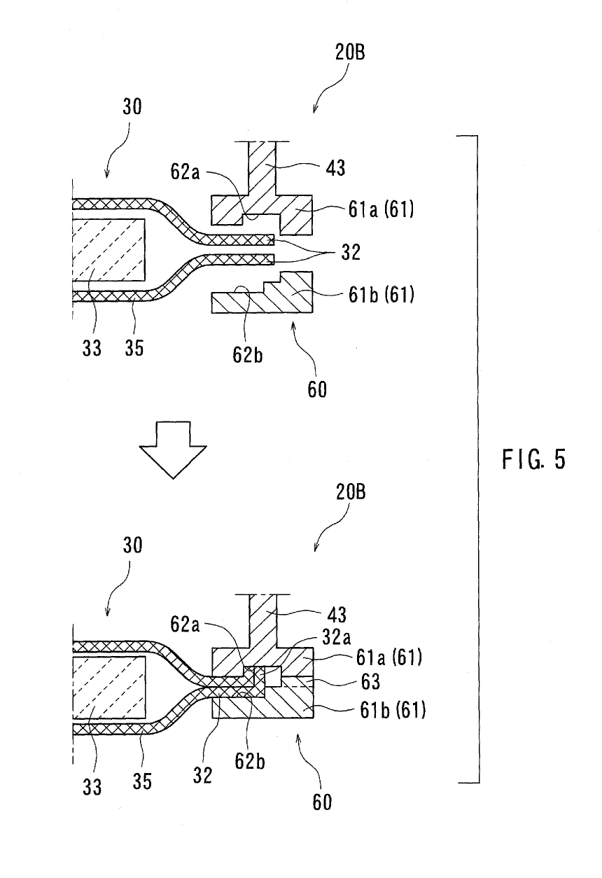

The second detailed representative embodiment will now described with reference to FIG. 5.

Because the second embodiment relates to the first embodiment, only the constructions and elements that are different from the first embodiment will be explained in detail. Elements that are the same in the first and second embodiments will be identified by the same reference numerals and a detailed description of such elements may be omitted.

As shown in FIG. 5, in a fuel filter 20B of this embodiment, the wall member 40 (40A) of the first embodiment is replaced with a wall member 60. The wall member 60 has a connecting portion 61 formed in the side wall portion 43 thereof. Unlike the connecting portion 41 of the first embodiment, the connecting portion 61 is constructed of two portions that are vertically separated from each other so as to hold or clamp the circumferential periphery 32 of the filter member 30 therebetween. In particular, the connecting portion 61 includes a first connecting element 61a that is integrated with the side wall portion 43, and a second connecting element 61b that is positioned opposite to the first connecting element 61a with interleaving the circumferential periphery 32 of the filter member 30 therebetween. Similar to the wall member 40 (40A) of the first embodiment, the wall member 60 may preferably be integrally formed of polyacetal resin having a melting point that is lower than the mesh filter element 35. Therefore, the first and second connecting elements 61a and 61b can be fusion bonded via a bonding portion 63 by heating, so as to be connected to or integrated with each other by fusion bonding while the circumferential periphery 32 of the filter member 30 is interleaved therebetween.

Further, as shown in FIG. 5, the first and second connecting elements 61a and 61b of the connecting portion 61 respectively have first and second holding portions 62a and 62b that are capable of reliably holding or clamping the circumferential periphery 32 of the filter member 30 therebetween when the first and second connecting elements 61a and 61b are fusion bonded via the bonding portion 63. The first holding portion 62a may preferably be formed as a recessed surface that is formed in a mating surface of the first connecting element 61a. Conversely, the second holding portion 62b may preferably be formed as a double shouldered surface that is formed in a mating surface of the second connecting element 61b. Further, the first and second holding portions 62a and 62b are respectively shaped such that the circumferential periphery 32 of the filter member 30 can be bent (upwardly) to form a bent portion 32a when the first and second connecting elements 61a and 61b are mated to each other and fusion bonded via the bonding portion 63 while the circumferential periphery 32 of the filter member 30 is clamped between the first and second holding portions 62a and 62b.

Thus, when the first and second connecting elements 61a and 61b are fusion bonded via the bonding portion 63 while the circumferential periphery 32 including the bent portion 32a of the filter member 30 is held or clamped between the first and second holding portions 62a and 62b, the connecting portion 61 formed in the side wall portion 43 can be securely bonded to the circumferential periphery 32 of the filter member 30, so that the wall member 60 can be integrated with the filter member 30. Therefore, a clearance possibly formed between the wall member 60 and the filter member 30 can reliably reduced or minimized, so that the gasoline G present in the container member S can be effectively prevented from escaping through the clearance.

### Third Embodiment

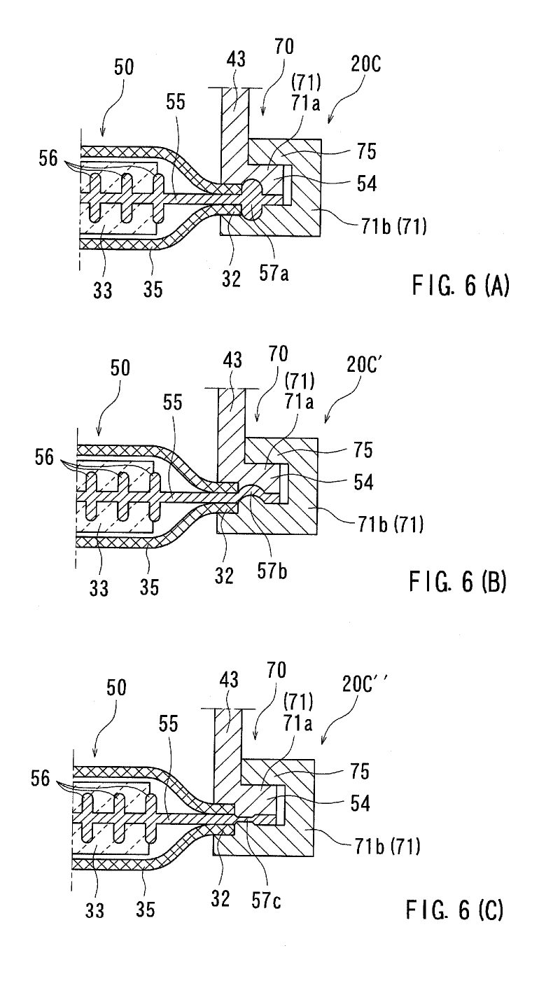

The third detailed representative embodiment will now described with reference to FIGS. 6(A) to 6(C).

Because the third embodiment relates to the second embodiment, only the constructions and elements that are different from the second embodiment will be explained in detail. Elements that are the same in the second and third embodiments will be identified by the same reference numerals and a detailed description of such elements may be omitted.

As shown in FIG. 6(A), in a fuel filter 20C of this embodiment, the filter member 30 of the second embodiment is replaced with a filter member 50. Unlike the filter member 30, the filter member 50 has a reinforcement member 55 that is embedded in the non-woven fabric filter element 33. The reinforcement member 55 has ribs 56 in order to effectively reinforcing or rigidifying the filter member 50. Further, the reinforcement member 55 may preferably be made of nylon resin similar to the nylon resin of the mesh filter element 35. The reinforcement member 55 is circumferentially sandwiched between the mesh sheets of the mesh filter element 35 and has a size greater than the mesh filter element 35. That is, the reinforcement member 55 is shaped such that a circumferential periphery 57a thereof can be projected outwardly beyond the circumferential periphery 32 of the filter member 50. Further, in this embodiment, the mesh sheets can be bonded along the circumferential peripheries thereof with interleaving the reinforcement member 55.

Conversely, the wall member 60 of the second embodiment is replaced with a wall member 70. The wall member 70 has a connecting portion 71 formed in the side wall portion 43 thereof. Similar to the connecting portion 61 of the second embodiment, the connecting portion 71 is constructed of two portions that are vertically separated from each other so as to hold or clamp the circumferential periphery 32 of the filter member 50 therebetween. In particular, the connecting portion 71 includes a first connecting element 71a that is integrated with the side wall portion 43, and a second connecting element 71b that is positioned opposite to the first connecting element 71a with interleaving the circumferential periphery 32 of the filter member 50 therebetween. Further, the wall member 70 (the connecting portion 71) is constructed to clamp the circumferential periphery 32 of the filter member 50 between the first connecting element 71a and the second connecting element 71b with the circumferential periphery 57a of the reinforcement member 55.

As shown in FIG. 6(A), the circumferential periphery 57a of the reinforcement member 55 has a thickened portion. In other words, the circumferential periphery 57a of the reinforcement member 55 has a pair of projected portions that are respectively vertically oppositely projected. Further, the connecting portion 71 (the first connecting element 71a and the second connecting element 71b) are respectively shaped to correspond to the projected portions of the circumferential periphery 57a of the reinforcement member 55.

Further, as shown in FIG. 6(A), the first connecting element 71a has an outwardly projected flange portion 54. Conversely, the second connecting element 71b has an engagement portion 75 having a U-shape in cross section. Therefore, the engagement portion 75 of the second connecting element 71b can engage the flange portion 54 of the first connecting element 71a while interleaving the circumferential periphery 32 of the filter member 50 and the circumferential periphery 57a of the reinforcement member 55 therebetween when the first and second connecting elements 71a and 71b are fusion bonded and integrated with each other. Further, the engagement portion 75 can be shaped to closely engage the flange portion 54, so that the first and second connecting elements 71a and 71b can be connected to or integrated with each other before the first and second connecting elements 71a and 71b are fusion bonded with each other.

According to the fuel filter 20C of this embodiment, the filter member 50 can be effectively rigidified by the reinforcement member 55. Further, the reinforcement member 55 has the thickened portion that is formed in the circumferential periphery 57a thereof. Therefore, when the connecting portion 71 is fusion bonded to the circumferential periphery 32 of the filter member 50 while the circumferential periphery 32 of the filter member 50 is clamped between the first connecting element 71a and the second connecting element 71b with the circumferential periphery 57a of the reinforcement member 55, the connecting portion 71 (the first connecting element 71a and the second connecting element 71b) can be bonded to the circumferential periphery 32 of the filter member 50 and the circumferential periphery 57a of the reinforcement member 55 with an enlarged total bonding area and an increased contact pressure. As a result, the connecting portion 71 can be reliably bonded to the circumferential periphery 32 of the filter member 50 and the circumferential periphery 57a of the reinforcement member 55, so that sealing performance therebetween can be increased.

The fuel filter 20C can be modified. First and second modified fuel filters 20C′ and 20C″ will be described with reference to FIGS. 6(B) and 6(C).

Because the first and second modified fuel filters 20C′ and 20C″ are similar to the fuel filter 20C, only the constructions and elements that are different from the fuel filter 20C will be explained in detail. Elements that are the same in the fuel filter 20C and the first and second modified fuel filters 20C′ and 20C″ will be identified by the same reference numerals and a detailed description of such elements may be omitted.

As shown in FIG. 6(B), in the first modified fuel filters 20C′, the reinforcement member 55 has a circumferential periphery 57b. The circumferential periphery 57b of the reinforcement member 55 has a curved portion that is upwardly curved. In other words, the circumferential periphery 57b of the reinforcement member 55 has a portion having a convex upper surface and a concave lower surface. Further, the connecting portion 71 (the first connecting element 71a and the second connecting element 71b) are respectively shaped to correspond to the curved portion of the circumferential periphery 57b of the reinforcement member 55.

As shown in FIG. 6(C), in the second modified fuel filters 20C″, the reinforcement member 55 has a circumferential periphery 57c. The circumferential periphery 57c of the reinforcement member 55 has a thinned portion. In other words, the circumferential periphery 57c of the reinforcement member 55 has a portion having depressed upper and lower surfaces. Further, the connecting portion 71 (the first connecting element 71a and the second connecting element 71b) are respectively shaped to correspond to the thinned portion of the circumferential periphery 57c of the reinforcement member 55.

### Fourth Embodiment

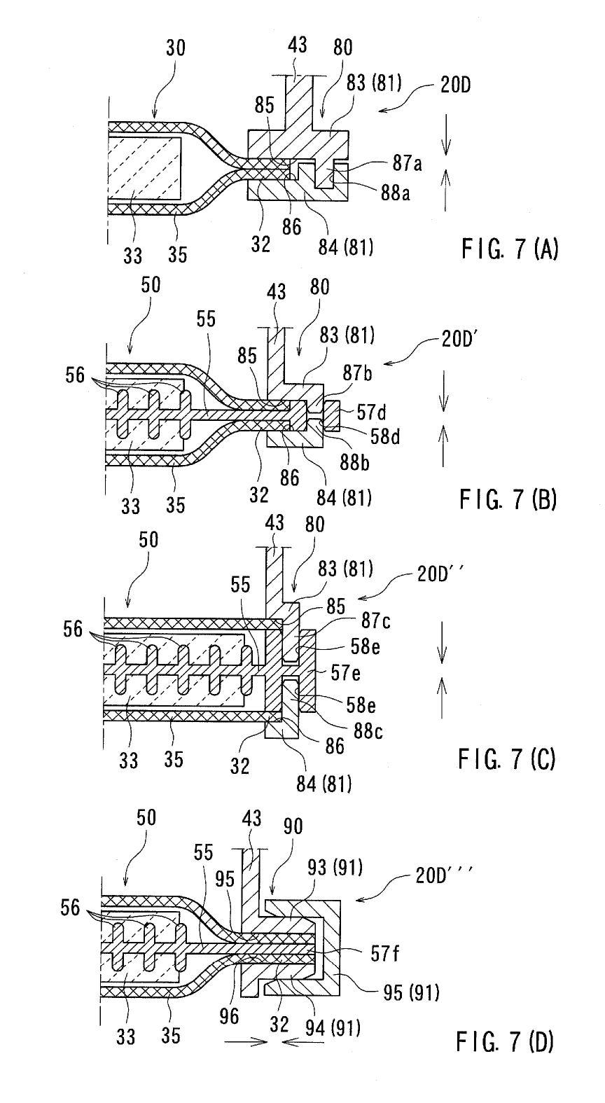

The fourth detailed representative embodiment will now described with reference to FIG. 7(A).

Because the fourth embodiment relates to the second embodiment, only the constructions and elements that are different from the second embodiment will be explained in detail. Elements that are the same in the second and fourth embodiments will be identified by the same reference numerals and a detailed description of such elements may be omitted.

As shown in FIG. 7(A), in a fuel filter 20D of this embodiment, the wall member 60 of the second embodiment is replaced with a wall member 80. Similar to the wall member 60, the wall member 80 has a connecting portion 81 formed in the side wall portion 43 thereof. Similar to the connecting portion 61 of the second embodiment, the connecting portion 81 is constructed of two portions that are vertically separated from each other so as to clamp the circumferential periphery 32 of the filter member 30 therebetween. In particular, the connecting portion 81 includes a first connecting element 83 that is integrated with the side wall portion 43, and a second connecting element 84 that is positioned opposite to the first connecting element 84 with interleaving the circumferential periphery 32 of the filter member 30 therebetween. However, unlike the first and second connecting elements 61a and 61b of the connecting portion 61, the first and second connecting elements 83 and 84 are connected to each other by fitting and not by fusion bonding, which will be hereinafter described.

Further, as shown in FIG. 7(A), the first and second connecting elements 83 and 84 of the connecting portion 81 respectively have first and second holding portions 85 and 86 that are capable of reliably holding or clamping the circumferential periphery 32 of the filter member 30 therebetween when the first and second connecting elements 83 and 84 are connected to or integrated with each other. The first holding portion 85 may preferably be formed as a flat surface that is formed in a mating surface of the first connecting element 83. The first holding portion 85 has a press-fitting projected portion 87a that is formed therein. The projected portion 87a is positioned along an outer periphery (a right periphery in the drawing) of the first holding portion 85 and is projected downwardly. Conversely, the second holding portion 86 may preferably be formed as a shouldered surface that is formed in a mating surface of the second connecting element 84. The second holding portion 86 has a press-fitting recessed portion 88a that is formed therein. The recessed portion 88a is positioned along an outer periphery (a right periphery in the drawing) of the second holding portion 86 so as to be depressed downwardly. Further, the projected portion 87a and the recessed portion 88a are positioned so as to correspond to each other and are respectively shaped to be capable of being press fitted to each other.

The projected portion 87a and the recessed portion 88a can be press fitted to each other while the circumferential periphery 32 of the filter member 30 is held or clamped between the first and second holding portions 85 and 86. Upon press fitting of the projected portion 87a and the recessed portion 88a, the first and second connecting elements 83 and 84 can be fitted or coupled to each other, so as to be connected to or integrated with each other while the circumferential periphery 32 of the filter member 30 is interleaved therebetween. Thus, the connecting portion 81 (the first and second connecting elements 83 and 84) formed in the side wall portion 43 can be securely connected to the circumferential periphery 32 of the filter member 30 by fitting, so that the wall member 80 can be integrated with the filter member 30.

### Fifth Embodiment

The fifth detailed representative embodiment will now described with reference to FIGS. 7(B) to 7(D).

Because the fifth embodiment relates to the third embodiment, only the constructions and elements that are different from the third embodiment will be explained in detail. Elements that are the same in the third and fifth embodiments will be identified by the same reference numerals and a detailed description of such elements may be omitted.

As shown in FIG. 7(B), in a fuel filter 20D′ of this embodiment, the wall member 70 of the third embodiment is replaced with a wall member 80. Similar to the wall member 70, the wall member 80 has a connecting portion 81 formed in the side wall portion 43 thereof. Similar to the connecting portion 71 of the third embodiment, the connecting portion 81 is constructed of two portions that are vertically separated from each other so as to clamp the circumferential periphery 32 of the filter member 50 therebetween. In particular, the connecting portion 81 includes a first connecting element 83 that is integrated with the side wall portion 43, and a second connecting element 84 that is positioned opposite to the first connecting element 83 with interleaving the circumferential periphery 32 of the filter member 50 therebetween. However, unlike the first and second connecting elements 71a and 71b of the connecting portion 71, the first and second connecting elements 83 and 84 are connected to each other by fitting and not by fusion bonding, which will be hereinafter described.

Further, as shown in FIG. 7(B), the first and second connecting elements 83 and 84 of the connecting portion 81 respectively have first and second holding portions 85 and 86 that are capable of reliably clamping the circumferential periphery 32 of the filter member 50 therebetween when the first and second connecting elements 83 and 84 are connected to or integrated with each other. The first holding portion 85 may preferably be formed as a flat surface that is formed in a mating surface of the first connecting element 83. The first holding portion 85 has a press-fitting projected portion 87b that is formed therein. The projected portion 87b is positioned along an outer periphery (a right periphery in the drawing) of the first holding portion 85 and is projected downwardly. Conversely, the second holding portion 86 may preferably be formed as a flat surface that is formed in a mating surface of the second connecting element 84. The second holding portion 86 has a press-fitting projected portion 88b that is formed therein. The projected portion 88b is positioned along an outer periphery (a right periphery in the drawing) of the second holding portion 86 so as to be projected upwardly. Further, the projected portion 87b and the projected portion 88b are oppositely positioned so as to correspond to each other.

Further, the reinforcement member 55 of the filter member 50 has a circumferential periphery 57d that is thickened and is projected outwardly beyond the circumferential periphery 32 of the filter member 50. The circumferential periphery 57d of the reinforcement member 55 has a pair of fitting grooves 58d that are respectively formed in upper and lower surfaces thereof. Further, the fitting grooves 58d are respectively shaped to be capable of being press fitted to the projected portions 87b and 88b of the connecting portion 81.

The projected portion 87b and the projected portion 88b can respectively be press fitted to the fitting grooves 58d while the circumferential periphery 32 of the filter member 50 is clamped between the first and second holding portions 85 and 86. Upon press fitting of the projected portions 87b and 88b of the wall member 80 and the fitting grooves 58d of the filter member 50, the first and second connecting elements 83 and 84 can be fitted or coupled to each other, so as to be connected to or integrated with each other while the circumferential periphery 32 of the filter member 50 is interleaved therebetween. Thus, the connecting portion 81 (the first and second connecting elements 83 and 84) formed in the side wall portion 43 can be securely connected to the circumferential periphery 32 of the filter member 50 by fitting, so that the wall member 80 can be integrated with the filter member 50.

The fuel filter 20D′ can be modified. First and second modified fuel filters 20D″ and 20D′″ will be described with reference to FIGS. 7(C) and 7(D).

Because the first and second modified fuel filters 20D″ and 20D′″ are similar to the fuel filter 20D′, only the constructions and elements that are different from the fuel filter 20D′ will be explained in detail. Elements that are the same in the fuel filter 20D′ and the first and second modified fuel filters 20D″ and 20D′″ will be identified by the same reference numerals and a detailed description of such elements may be omitted.

As shown in FIG. 7(C), in the first modified fuel filters 20D″, the first holding portion 85 has a press-fitting projected portion 87c that is formed therein. The projected portion 87c is positioned along an outer periphery (a right periphery in the drawing) of the first holding portion 85 and is projected downwardly. Conversely, the second holding portion 86 has a press-fitting projected portion 88c that is formed therein. The projected portion 88c is positioned along an outer periphery (a right periphery in the drawing) of the second holding portion 86 so as to be projected upwardly. Further, the projected portion 87c and the projected portion 88c are lengthened than the projected portion 87b and the projected portion 88b.

Further, in the first modified fuel filters 20D″, the reinforcement member 55 has a circumferential periphery 57e that is thickened and is partially projected outwardly beyond the circumferential periphery 32 of the filter member 50 and has a thickness greater than the circumferential periphery 57d. The circumferential periphery 57e of the reinforcement member 55 has a pair of fitting grooves 58e that are respectively formed in upper and lower surfaces thereof. Further, the fitting grooves 58e are respectively shaped to be capable of being press fitted to the projected portions 87c and 88c of the connecting portion 81. Further, each of the fitting grooves 58e has a depth greater than each of the fitting grooves 58d so as to receive each of the projected portions 87c and 88c therein. According to this modified form, the projected portion 87b and the projected portion 88b can be reliably press fitted to the fitting grooves 58e.

As shown in FIG. 7(D), in the second modified fuel filters 20D′″, the wall member 80 is replaced with a wall member 90. Similar to the wall member 80, the wall member 90 has a connecting portion 91 formed in the side wall portion 43 thereof. However, unlike the connecting portion 81, the connecting portion 91 is constructed of two portions that are vertically separated from each other so as to clamp the circumferential periphery 32 of the filter member 50 therebetween, and an additional portion. In particular, the connecting portion 91 includes a first connecting element 93 that is integrated with the side wall portion 43, a second connecting element 94 that is positioned opposite to the first connecting element 93 with interleaving the circumferential periphery 32 of the filter member 50 therebetween, and a fastener 95 that is capable of fastening the first and second connecting element 93 and 94 while the circumferential periphery 32 of the filter member 50 is clamped therebetween with a circumferential periphery 57f of the reinforcement member 55. Further, the first and second connecting elements 93 and 94 of the connecting portion 91 respectively have first and second holding portions 95 and 96.

Further, in the fuel filters 20D′″, the first and second connecting elements 93 and 94 do not include portions corresponding to the projected portions 87b and 88b of the fuel filter 20D′. Conversely, the circumferential periphery 57f of the reinforcement member 55 is not thickened and is not projected outwardly beyond the circumferential periphery 32 of the filter member 50. In addition, the circumferential periphery 57f of the reinforcement member 55 does not have grooves corresponding to the fitting grooves 58d. As a result, the wall member 90 is integrally connected to the circumferential periphery 32 of the filter member 50 without contacting the circumferential periphery 57f of the reinforcement member 55. Further, the first and second connecting elements 93 and 94, the circumferential periphery 32 of the filter member 50 and the circumferential periphery 57f of the reinforcement member 55 are respectively shaped such that end surfaces thereof can be flush with each other.

The fastener 95 can be press fitted to the first and second connecting elements 93 and 94 while the circumferential periphery 32 of the filter member 50 is clamped between the first and second holding portions 95 and 96. When the fastener 95 is press fitted to the first and second connecting elements 93 and 94 of the wall member 90, the first and second connecting elements 93 and 94 can be fitted or coupled to each other via the fastener 95, so as to be connected to or integrated with each other while the circumferential periphery 32 of the filter member 50 is interleaved therebetween. Thus, the connecting portion 91 (the first and second connecting elements 93 and 94) formed in the side wall portion 43 can be securely connected to the circumferential periphery 32 of the filter member 50 by fitting, so that the wall member 90 can be integrated with the filter member 50.

### Sixth Embodiment

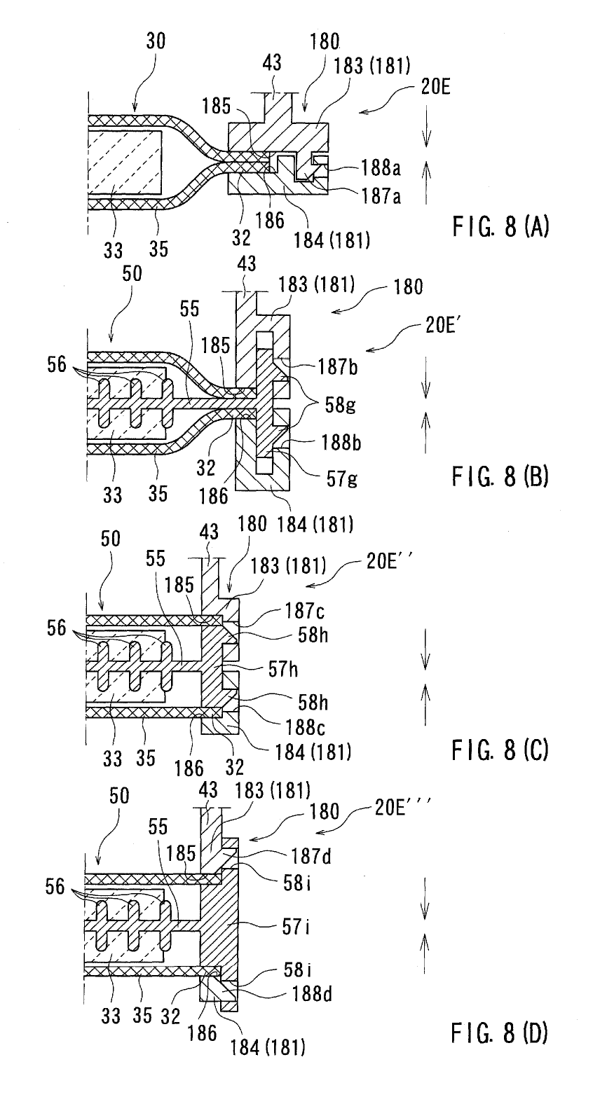

The sixth detailed representative embodiment will now described with reference to FIG. 8(A).

Because the sixth embodiment relates to the fourth embodiment, only the constructions and elements that are different from the fourth embodiment will be explained in detail. Elements that are the same in the fourth and sixth embodiments will be identified by the same reference numerals and a detailed description of such elements may be omitted.

As shown in FIG. 8(A), in a fuel filter 20E of this embodiment, the wall member 80 of the fourth embodiment is replaced with a wall member 180. Similar to the wall member 80, the wall member 180 has a connecting portion 181 formed in the side wall portion 43 thereof. Similar to the connecting portion 81 of the fourth embodiment, the connecting portion 181 is constructed of two portions that are vertically separated from each other so as to clamp the circumferential periphery 32 of the filter member 30 therebetween. In particular, the connecting portion 181 includes a first connecting element 183 that is integrated with the side wall portion 43, and a second connecting element 184 that is positioned opposite to the first connecting element 184 with interleaving the circumferential periphery 32 of the filter member 30 therebetween.

Further, the first and second connecting elements 183 and 184 of the connecting portion 181 respectively have first and second holding portions 185 and 186 that are capable of reliably clamping the circumferential periphery 32 of the filter member 30 therebetween when the first and second connecting elements 183 and 184 are connected to or integrated with each other. The first holding portion 185 may preferably be formed as a flat surface that is formed in a mating surface of the first connecting element 183. The first holding portion 185 has a male hook portion 187a that is formed therein. The male hook portion 187a is positioned along an outer periphery (a right periphery in the drawing) of the first holding portion 185 and is projected downwardly. Conversely, the second holding portion 186 may preferably be formed as a shouldered surface that is formed in a mating surface of the second connecting element 184. The second holding portion 186 has a female hook portion 188a that is formed therein. The female hook portion 188a is positioned along an outer periphery (a right periphery in the drawing) of the second holding portion 186 so as to be depressed downwardly. Further, the male hook portion 187a and the female hook portion 188a are positioned so as to correspond to each other and are respectively shaped to be capable of being hooked with each other.

The projected portion 187a and the recessed portion 188a can be hooked or snap fitted to each other while the circumferential periphery 32 of the filter member 30 is clamped between the first and second holding portions 185 and 186. Upon snap fitting of the projected portion 187a and the recessed portion 188a, the first and second connecting elements 183 and 184 can be fitted or coupled to each other, so as to be connected to or integrated with each other while the circumferential periphery 32 of the filter member 30 is interleaved therebetween. Thus, the connecting portion 181 (the first and second connecting elements 183 and 184) formed in the side wall portion 43 can be securely connected to the circumferential periphery 32 of the filter member 30 by fitting, so that the wall member 180 can be integrated with the filter member 30.

### Seventh Embodiment

The seventh detailed representative embodiment will now described with reference to FIGS. 8(B) to 8(D).

Because the seventh embodiment relates to the fifth embodiment, only the constructions and elements that are different from the fifth embodiment will be explained in detail. Elements that are the same in the fifth and seventh embodiments will be identified by the same reference numerals and a detailed description of such elements may be omitted.

As shown in FIG. 8(B), in a fuel filter 20E′ of this embodiment, the wall member 80 of the fifth embodiment is replaced with a wall member 180. Similar to the wall member 80, the wall member 180 has a connecting portion 181 formed in the side wall portion 43 thereof. Similar to the connecting portion 81 of the fifth embodiment, the connecting portion 181 is constructed of two portions that are vertically separated from each other so as to clamp the circumferential periphery 32 of the filter member 50 therebetween. In particular, the connecting portion 181 includes a first connecting element 183 that is integrated with the side wall portion 43 and has an outer wall portion, and a second connecting element 184 that is positioned opposite to the first connecting element 183 with interleaving the circumferential periphery 32 of the filter member 50 therebetween and has an outer wall portion.

Further, as shown in FIG. 8(B), the first and second connecting elements 183 and 184 of the connecting portion 181 respectively have first and second holding portions 185 and 186 that are capable of reliably clamping the circumferential periphery 32 of the filter member 50 therebetween when the first and second connecting elements 183 and 184 are connected to or integrated with each other. The first holding portion 185 may preferably be formed as a flat surface that is formed in a mating surface of the first connecting element 183. The first connecting element 183 has a female hook portion 187b that is formed therein. In particular, the female hook portion 187b is formed in the outer wall portion of the first connecting element 183. Conversely, the second holding portion 186 may preferably be formed as a flat surface that is formed in a mating surface thereof. The second connecting element 184 has a female hook portion 188b that is formed therein. In particular, the female hook portion 188b is formed in the outer wall of the second connecting element 184.

Further, the reinforcement member 55 of the filter member 50 has a circumferential periphery 57g that is thickened and projected outwardly beyond the circumferential periphery 32 of the filter member 50. The circumferential periphery 57g of the reinforcement member 55 has a pair of male hook portions 58g that are respectively formed in an outer end surface thereof. Further, the male hook portions 58g are respectively shaped to be capable of being hooked or snap fitted to the female hook portions 187b and 188b of the connecting portion 181.

The male hook portions 58g can respectively be snap fitted to the female hook portions 187b and 188b while the circumferential periphery 32 of the filter member 50 is clamped between the first and second holding portions 185 and 186. Upon snap fitting of the female hook portions 187b and 188b of the wall member 180 and the male hook portions 58g of the filter member 50, the first and second connecting elements 183 and 184 can be fitted or coupled to each other, so as to be connected to or integrated with each other while the circumferential periphery 32 of the filter member 50 is interleaved therebetween. Thus, the connecting portion 181 (the first and second connecting elements 183 and 184) formed in the side wall portion 43 can be securely connected to the circumferential periphery 32 of the filter member 50 by fitting, so that the wall member 180 can be integrated with the filter member 50.

The fuel filter 20E′ can be modified. First and second modified fuel filters 20E″ and 20E′″ will be described with reference to FIGS. 8(C) and 8(D).

Because the first and second fuel filters 20E″ and 20E′″ are similar to the fuel filter 20E′, only the constructions and elements that are different from the fuel filter 20E′ will be explained in detail. Elements that are the same in the fuel filter 20E′ and the first and second modified fuel filters 20E″ and 20E′″ will be identified by the same reference numerals and a detailed description of such elements may be omitted.

As shown in FIG. 8(C), in the first modified fuel filters 20E″, the first connecting element 183 has a female hook portion 187c that is formed therein. Conversely, the second connecting element 184 has a female hook portion 188c that is formed therein.

Further, in the fuel filters 20E″, the reinforcement member 55 has a circumferential periphery 57h that is thickened and is substantially aligned with the circumferential periphery 32 of the filter member 50. The circumferential periphery 57h of the reinforcement member 55 has a pair of male hook portions 58h that are respectively formed in an outer end surface thereof. Further, the male hook portions 58h are respectively shaped to be capable of being hooked or snap fitted to the female hook portions 187c and 188c of the connecting portion 181.

The male hook portions 58h can respectively be snap fitted to the female hook portions 187c and 188c while the circumferential periphery 32 of the filter member 50 is clamped between the first and second holding portions 185 and 186 with the circumferential periphery 57h of the reinforcement member 55. Upon snap fitting of the female hook portions 187c and 188c of the wall member 180 and the male hook portions 58h of the filter member 50, the first and second connecting elements 183 and 184 can be fitted or coupled to each other, so as to be connected to or integrated with each other while the circumferential periphery 32 of the filter member 50 is interleaved therebetween. Thus, the connecting portion 181 (the first and second connecting elements 183 and 184) formed in the side wall portion 43 can be securely connected to the circumferential periphery 32 of the filter member 50 by fitting, so that the wall member 180 can be integrated with the filter member 50.

As shown in FIG. 8(D), in the second modified fuel filters 20E′″, the first connecting element 183 has a male hook portion 187d that is formed therein. In particular, the male hook portion 187d is formed in an outer end surface of the first connecting element 183. Conversely, the second connecting element 184 has a male hook portion 188d that is formed therein. In particular, the male hook portion 188d is formed in an outer end surface of the second connecting element 184.

Further, in the fuel filters 20E′″, the reinforcement member 55 has a shouldered circumferential periphery 57i that is thickened and is partially projected outwardly beyond the circumferential periphery 32 of the filter member 50. The circumferential periphery 57i has upper and lower flanged portions that are formed in an outwardly projected portion thereof. The circumferential periphery 57i of the reinforcement member 55 has a pair of female hook portions 58i that are respectively formed in the upper and lower flanged portions thereof. Further, the female hook portions 58i are respectively shaped to be capable of being hooked or snap fitted to the male hook portions 187d and 188d of the connecting portion 181.

The male hook portions 187d and 188d can respectively be snap fitted to the female hook portions 58i while the circumferential periphery 32 of the filter member 50 is clamped between the first and second holding portions 185 and 186 with the circumferential periphery 57i of the reinforcement member 55. Upon snap fitting of the male hook portions 187d and 188d of the wall member 180 and the female hook portions 58i of the filter member 50, the first and second connecting elements 183 and 184 can be fitted or coupled to each other, so as to be connected to or integrated with each other while the circumferential periphery 32 of the filter member 50 is interleaved therebetween. Thus, the connecting portion 181 (the first and second connecting elements 183 and 184) formed in the side wall portion 43 can be securely connected to the circumferential periphery 32 of the filter member 50 by fitting, so that the wall member 180 can be integrated with the filter member 50.

### Eighth Embodiment

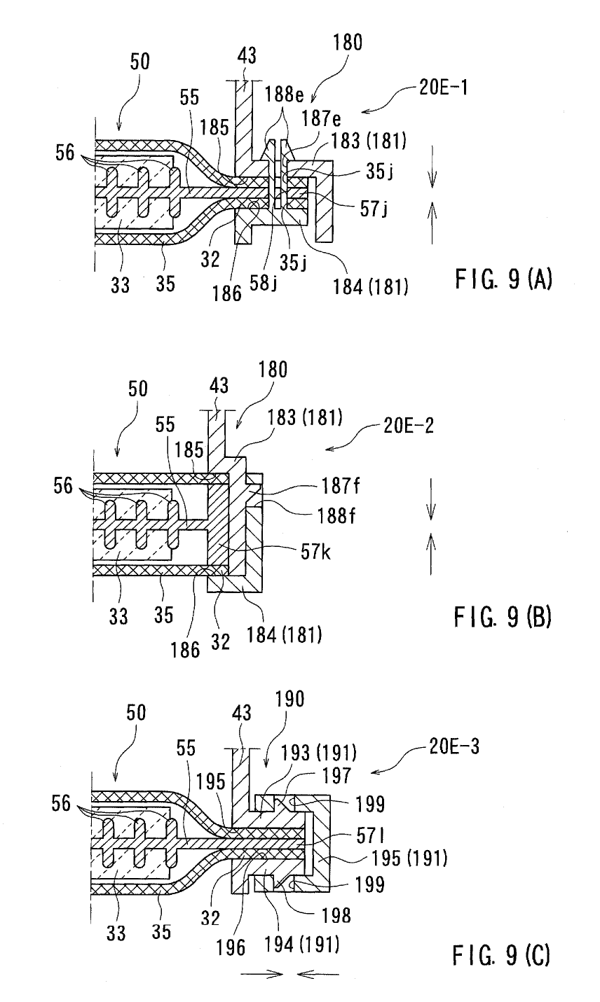

The eighth detailed representative embodiment will now described with reference to FIGS. 9(A) to 9(C).

Because the eighth embodiment relates to the seventh embodiment, only the constructions and elements that are different from the seventh embodiment will be explained in detail. Elements that are the same in the seventh and eighth embodiments will be identified by the same reference numerals and a detailed description of such elements may be omitted.

As shown in FIG. 9(A), in a fuel filter 20E-1 of this embodiment, the first connecting element 183 has a female hook portion 187e that is formed therein. The female hook portion 187e is positioned in a central portion of the first holding portion 185. Conversely, the second connecting element 184 has a pair of male hook portions 188e that is formed therein. The female hook portions 188e are positioned to correspond to the female hook portion 187e.

Further, the reinforcement member 55 of the filter member 50 has a circumferential periphery 57j that is positioned in the circumferential periphery 32 of the filter member 50. The circumferential periphery 57j of the reinforcement member 55 has a through hole 58j that is vertically penetrated therethrough. Further, the circumferential periphery 32 of the filter member 50 has through holes 35j that are vertically penetrated therethrough so as to correspond to the through hole 58j formed in the circumferential periphery 57j. As will be recognized, the male hook portions 188e of the second connecting element 184 are respectively shaped to be capable of being hooked or snap fitted to the female hook portions 187e of the first connecting element 183 via the through holes 35j and 58j.

The male hook portions 188e can respectively be snap fitted to the female hook portions 187e while the circumferential periphery 32 of the filter member 50 is clamped between the first and second holding portions 185 and 186. Upon snap fitting of the female hook portions 187e of the first connecting element 183 and the male hook portions 188e of the second connecting element 184, the first and second connecting elements 183 and 184 can be fitted or coupled to each other, so as to be connected to or integrated with each other while the circumferential periphery 32 of the filter member 50 is interleaved therebetween. Thus, the connecting portion 181 (the first and second connecting elements 183 and 184) formed in the side wall portion 43 can be securely connected to the circumferential periphery 32 of the filter member 50 by fitting, so that the wall member 180 can be integrated with the filter member 50.

The fuel filter 20E-1 can be modified. First and second modified fuel filters 20E-2 and 20E-3 will be described with reference to FIGS. 9(B) and 9(C).

Because the first and second modified fuel filters 20E-2 and 20E-3 are similar to the fuel filter 20E-1, only the constructions and elements that are different from the fuel filter 20E-1 will be explained in detail. Elements that are the same in the fuel filter 20E-1 and the first and second modified fuel filters 20E-2 and 20E-3 will be identified by the same reference numerals and a detailed description of such elements may be omitted.

As shown in FIG. 9(B), in the first modified fuel filters 20E-2, the first connecting element 183 has a male hook portion 187f that is formed therein. The male hook portion 187f is outwardly projected from an outer surface of the first connecting element 183. Conversely, the second connecting element 184 has a female hook portion 188f that is formed therein. The female hook portion 188f is positioned to correspond to the male hook portion 187f. Further, in the fuel filters 20E-2, the reinforcement member 55 has a circumferential periphery 57k that is thickened and is substantially aligned with the circumferential periphery 32 of the filter member 50.

The male hook portions 187f can be snap fitted to the female hook portions 188f while the circumferential periphery 32 of the filter member 50 is clamped between the first and second holding portions 185 and 186 with the circumferential periphery 57k of the reinforcement member 55. Upon snap fitting of the male hook portions 187f of the first connecting element 183 and the female hook portions 188f of the second connecting element 184, the first and second connecting elements 183 and 184 can be fitted or coupled to each other, so as to be connected to or integrated with each other while the circumferential periphery 32 of the filter member 50 is interleaved therebetween. Thus, the connecting portion 181 (the first and second connecting elements 183 and 184) formed in the side wall portion 43 can be securely connected to the circumferential periphery 32 of the filter member 50 by fitting, so that the wall member 180 can be integrated with the filter member 50.

As shown in FIG. 9(D), in the second modified fuel filters 20E-3, the wall member 180 is replaced with a wall member 190. Similar to the wall member 180, the wall member 190 has a connecting portion 191 formed in the side wall portion 43 thereof. However, unlike the connecting portion 181, the connecting portion 191 is constructed of two portions that are vertically separated from each other so as to clamp the circumferential periphery 32 of the filter member 50 therebetween, and an additional portion. In particular, the connecting portion 191 includes a first connecting element 193 that is integrated with the side wall portion 43, a second connecting element 194 that is positioned opposite to the first connecting element 193 with interleaving the circumferential periphery 32 of the filter member 50 therebetween, and a fastener 195 that is capable of being attached to the first and second connecting element 193 and 194 while the circumferential periphery 32 of the filter member 50 is clamped therebetween with a circumferential periphery 1571 of the reinforcement member 55. Further, the first and second connecting elements 193 and 194 of the connecting portion 191 respectively have first and second holding portions 195 and 196.

As shown in FIG. 9(D), in the second modified fuel filters 20E-3, the first connecting element 193 has a male hook portion 197 that is formed therein. The male hook portion 197 is upwardly projected from an upper surface of the first connecting element 193. Similarly, the second connecting element 194 has a male hook portion 198 that is formed therein. The male hook portion 198 is downwardly projected from a lower surface of the second connecting element 194. Conversely, the fastener 195 has a pair of female hook portions 199 that are respectively formed in upper and lower walls thereof. The female hook portions 199 respectively correspond to the male hook portions 197 and 198, so as to be snap fitted to the male hook portions 197 and 198 when the fastener 195 is attached to the first and second connecting element 193 and 194.

Thus, in the second modified fuel filters 20E-3, the fastener 195 can be attached to the first and second connecting elements 193 and 194 while the circumferential periphery 32 of the filter member 50 is clamped between the first and second holding portions 195 and 196. When the fastener 195 is attached to the first and second connecting elements 193 and 194 of the wall member 190, the female hook portions 199 can be snap fitted to the male hook portions 197 and 198. As a result, the first and second connecting elements 193 and 194 can be fitted or coupled to each other via the fastener 195, so as to be connected to or integrated with each other while the circumferential periphery 32 of the filter member 50 is interleaved therebetween. Thus, the connecting portion 191 (the first and second connecting elements 193 and 194) formed in the side wall portion 43 can be securely connected to the circumferential periphery 32 of the filter member 50 by fitting, so that the wall member 190 can be integrated with the filter member 50.

According to the forth to eighth embodiment, each of the wall members 80, 90, 180 and 190 can be integrated with each of the filter members 30 and 50 without using fusion bonding method. Therefore, each of the wall members 80, 90, 180 and 190 can be easily and quickly integrated with each of the filter members 30 and 50. As a result, a work for manufacturing each of the fuel filters 20D, 20D′, 20D″, 20D′″, 20E, 20E′, 20E″, 20E′″, 20E-1, 20E-2 and 20E-3 can be simplified.

Various changes and modifications may be made to the fuel filter of each of the embodiments. For example, the wall member may have various shapes.

Representative examples of the present invention have been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A fuel filter for filtering engine fuel received in a fuel tank when the engine fuel is fed to an engine, comprising:
a filter member that is received in the fuel tank and is capable of being connected to a fuel inlet port through which the engine fuel is drawn, and
a wall member that is connected to a circumferential periphery of the filter member to form a container member,
wherein the wall member and the filter member are respectively arranged and constructed to function as a side portion and a bottom portion of the container member, and
wherein the filter member is capable of being disposed in the fuel tank so as to draw the engine fuel received in the fuel tank through a side thereof that faces the bottom wall of the fuel tank.

2. The fuel filter as defined in claim 1, wherein the filter member is composed of a non-woven fabric filter element that is capable of filtering fine contaminants contained in the engine fuel, and a mesh filter element that is positioned to encapsulate the non-woven fabric filter element, and wherein the mesh filter element has a function to absorb the engine fuel thereon.

3. The fuel filter as defined in claim 1, wherein the wall member is made of a material that has a melting point lower than the circumferential periphery of the filter member, and wherein the wall member can be connected to the circumferential periphery of the filter member by fusion bonding, so as to be integrated with the filter member.

4. The fuel filter as defined in claim 1, wherein the wall member can be connected to the circumferential periphery of the filter member by fitting, so as to be integrated with the filter member.

5. A fuel filter, comprising:
a filter member that is capable of being connected to a suction pipe of a fuel-feeding device, and
a wall member that is connected to a circumferential periphery of the filter member to form a container member,
wherein the wall member and the filter member are respectively arranged and constructed to function as a side portion and a bottom portion of the container member, and
wherein the container member is capable of being disposed in a fuel tank while the fuel member is positioned adjacent to a bottom wall of the fuel tank.
